(19) United States
(12) Patent Application Publication
(10) Pub. No.: US 2017/0116590 A1
(43) Pub. Date: Apr. 27, 2017

(54) A METHOD AND SYSTEM FOR COMPLETING TRANSACTIONS

(71) Applicant: ecrebo Limited, Marlow Buckinghamshire (GB)

(72) Inventors: Yosuke Ozawa, Marlow Buckinghamshire (GB); Hassan Hajji, Marlow Buckinghamshire (GB)

(21) Appl. No.: 15/307,735

(22) PCT Filed: Apr. 30, 2015
(86) PCT No.: PCT/GB2015/051268

§ 371 Date: Oct. 28, 2016

(30) Foreign Application Priority Data
Apr. 30, 2014 (GB) 1407639.2

(51) Int. Cl. G06Q 20/20; G06Q 20/32; G06Q 20/10

(52) U.S. Cl. CPC G06Q 20/202; G06Q 20/102; G06Q 20/3276

(57) ABSTRACT

A transaction server for managing a merchant-user transaction between a point-of-sale system of a merchant and a user computing device, the server comprising: an input arranged to receive transaction data from the point-of-sale system and to receive a user request from the user computing device to complete the merchant-user transaction between the point-of-sale system and the user computing device; a processor arranged to complete the merchant-user transaction by running a payment process in dependence on the received transaction data and user request; an output arranged to output a transaction complete communication to the point-of-sale system.

### FIELD OF THE INVENTION

The present invention relates to a method and system for completing transactions. The present invention extends to the payment process for completing transactions and provides methods and systems that allow payments to be made within retail environments.

### BACKGROUND

The completion of a transaction m restaurants, cafe or shops may sometimes be difficult due to a busy retail environment. This may in turn lead to delays for customers (who are not able to complete the transaction so they can leave the retail environment) and retailers (who may not be able to reset the location, e.g. a restaurant, for the next customer).

From the customer's point of view, the transaction completion process may be a time consuming event since it may comprise 3 (or more) steps: (1). Call waiter or waitress to customer's table. (2) Ask for a bill; (3) Ask to pay with credit card. Compounding the ability to complete the transaction is the fact that, at each step, a customer will need to wait until a retail serving staff member comes to their tables. The staff and the number of Process Data Quickly (PDQ) Terminals may cause a bottleneck in enabling the transaction to be completed.

For the retailer (e.g. a restaurant), these three steps make their staff busy and may require more resources to handle this situation or customers need to wait longer. Within the restaurant environment a further complicating factor is that transactions are more likely to be completed at around the same time than in other retail environments since customers are likely to start eating and therefore finishing their meals at around the same time

In WO2013068767 a system and method is given to enable payment via QR-codes scanning. When a customer scans a QR code with a code scanner, the merchant identification code encoded within the QR code is recovered, and the code scanner might show the invoice data and one or multiple payment instruments. After the customer selects a payment instrument, the code scanner sends the merchant identification code, data pertaining to the selected payment instrument, and al least a portion of the invoice data to an application server for attending to pay the invoice. The application server tries to pay for the invoice and notify the code scanner with the result end the scanner can show the result.

In US20130252309 a system and method is given to enable secure payment via QR-codes scanning. After the creation of a payer user account, the payer user can pay a bill by scanning a QR code that encodes the bill payment information securely. A payee needs to input the bill payment information before payers try to pay in this system and a payee or a payer need to access a central server to know the state of the payment for the specific bill.

The aim of the present invention is to provide a payment system/process that overcomes or substantially mitigates the above mentioned problems.

### STATEMENT OF INVENTION

According to a first aspect of the present invention there is provided a transaction server for managing a merchant-user transaction between a point-of-sale system of a merchant and a user computing device, the server comprising; an input arranged to receive transaction data from the point-of-sale system and to receive a user request from the user computing device to complete the merchant-user transaction between the point-of-sale system and the user computing device; a processor arranged to complete the merchant-user transaction by running a payment process in dependence on the received transaction data and user request; an output arranged to output a transaction complete communication to the point-of-sale system.

The present invention provides a transaction server (also referred to herein as the payment server) that facilitates the management of a transaction between a point of sale system of a merchant and a user computing device of a user engaged in a transaction at the merchant. The server according to the first aspect of the invention provides an arrangement that extends the functionality of a point of sale system to allow users to enter into the transaction completion process (for example the “requesting a bill” and “settling a bill” stage). The payment process run by the processor may comprise, amongst other things, retrieving transaction data (that has been stored during an ongoing transaction) upon receiving the user request, requesting further transaction data from the point-of-sale system, issuing a bill, providing payment instructions to the user device, processing payment tokens, communicating with a third party payment provider.

The user request from the user computing device to complete the merchant-user transaction may comprise a communication requesting a bill is raised for the merchant-user transaction. The user request may also comprise a communication requesting that a bill is issued.

The transaction complete communication may comprise a communication to the point-of-sale system to print a receipt or a communication to the point-of-sale system that payment has been received and/or the transaction is complete. The transaction complete communication may comprise an authorization code from a third party payment provider when the user payment was authorized User payment card details (or parts thereof) may also be included within the transaction complete communication. The transaction complete communication may also comprise a bill identifier. The transaction complete communication may also comprise a location identifier or a basket identifier or a user identifier.

The user computing device may compose a smart device such as a smartphone or tablet computing device. The user computing device may also comprise any computing device, such as a smart watch, that can receive and transmit communications to the payment server and communicate with a third party payment, provider (e.g. an issuing bank of a payment card belonging to me user of a payment network such as MasterCard or VISA).

Transaction data from the point of sale system may comprise a whole transaction (e.g. all transaction items acquired in the transaction) or part of the transaction (for example, in the context of a restaurant a customer (user) may add transaction items to their overall order in stages (such as additional courses or drinks)). In such a context transaction data may be periodically sent to the transaction server from the point of sale system and stored in a basket database until the user wishes to pay the final bill.

The point of sale system may be modified to enable transaction data to be supplied to the transaction server, in one example, the point of sale operating software may be modified to send the transaction data In an alternative example, an interceptor module may be installed on the point of sale system to intercept transaction data being sent in the communication path between a point of sale terminal and a physical device such as a printer or scanner. Such intercepted transaction data may be then sent to the server by the interceptor module.

Conveniently therefore the input may receive transaction data from an interceptor module at the point-of-sale system, the interceptor module being arranged to intercept transaction data in the communication path between a point-of-sale terminal and a physical device and to send the intercepted transaction data to the server.

The transaction data received from the point-of-sale system may comprise a transaction identifier. The transaction identifier may be generated by the point of sale system or may be generated by the server in an earlier data exchange (e.g. a client set up process). The transaction identifier may be used by the server to distinguish data arriving from various different transactions that are being handled in parallel. The transaction data once distinguished may be stored in a basket pending completion of the transaction process. The transaction identifier may be a basket ID or a location ID that identifies where a user is located within a merchant (e.g. in the example of a restaurant the location ID may comprise a table location.

The transaction data received from the point-of-sale system may comprise transaction item data. As noted above, the transaction may relate to multiple items and the point of sale system may provide that data to the server. Also as noted above there may be more than one transmission of transaction data to the server in the context of a single transaction. For example, initial items acquired in the transaction may be in one transmission and further items acquired later in the same transact-on may be in a further transaction.

The transaction item data may comprise a transaction item identifier and associated transaction item price data for each transaction item identifier. Each transaction item may be associated with a price. The transaction item data may therefore comprise details of the item itself and the price of that item. The exchange of this data later enables a(n) (electronic bill) to be generated.

Transaction data may be received from the point-of-sale system prior to receiving the user request from the user. Transaction data may be received at the transaction server in a number of modes. For example, the transaction data may be collected as the order progresses Alternatively, the transaction data may be acquired in “one hit” by the server at the end of the transaction.

The processor may be arranged to open a data record in a basket database upon receiving transaction data, in order that the server can track the progress of the transaction it may open a record in a database.

The processor may be arranged to populate the basket database with received transaction item data. Transaction data received from the point of safe may be added to the database until the user wishes to “settle up”. It is noted that the above transaction identifier, in the context of a basket ID, may be used to allocate the received data for storage in the database. The point of sale system, or me interceptor module, may include the basket ID with the transaction data]

The server may be arranged to request transaction data from the point-of-sale system upon receipt of the user request. In the “alternative” collection mode referenced above the transaction data may be acquired in “one hit” by the server at the end of the transaction in this case the receipt of the user request prompts the server to ask the POS for the data it needs.

The user request received at the input may comprise a request tor a bill and the processor may be arranged to retrieve transaction data relating to the merchant-user transaction and to generate a bill for the user. The bill may be sent to the user directly or via the point of sale system.

Transaction data relating to the transaction may comprise at least one transaction item identifier and associated transaction item price data. Such transaction data may either retrieved from server database if it is storing the data or from the point of sale system.

The processor may be arranged to generate an electronic bill and the output may be arranged to output the electronic bill. The electronic bill may be sent to the user computing device or additionally/alternatively to the point-of-sale system. In the latter instance the merchant may receive the bill and print a copy to be passed to the user

The processor may be arranged to provide, within the electronic bill, connection details relating to a third party payment processor. If the user is going to settle their bin direct with a third party payment provider rather than using the restaurant's payment terminal then the user needs to details on how to pay. In one example, the electronic bin may be sent directly to the customer and may include a link (e.g. a URL) to the payment processor. In an alternative example, the electronic bill may be sent to the point of sale system for printing as a paper bill. In this alternative scenario the processor may include as part of the electronic bill instructions for printing a scannable identifier as part of the process of printing a physical copy of the bill. The scannable identifier may encode details to the user device on how to conned to the payment processor. In use, the user may scan the identifier using their user device (e.g. using a camera on a mobile phone) using a program application (“app”) running on the user device in order to connect to the payment processor.

The input may be arranged to receive a payment token front the user computing device and the server (processor) may subsequently as part of completing the merchant-user transaction be arrayed to initiate a communication session with the third party payment processor in order to submit the payment token to the third party payment processor in order to receive a refund corresponding Jo the total transaction amount.

The input may be arranged to receive a foil identifier (a Bill ID as described herein) from the user device in addition to the payment token to enable the processor to retrieve all transaction data relating to the merchant-user transaction.

The user request may comprise a transaction identifier to allow the server to identify the merchant-user transaction. In other words, in the “requesting a bill” interaction between the user and the merchant the user request may comprise a transaction identifier so that the server can retrieve relevant transaction data The transaction identifier may be a basket identifier, e.g. if the server maintains a basket of transaction items ordered by the user, this basket may have an identifier. If the user has been presented with this basket identifier (for instance during the ordering process) then the user request may include the basket identifier. The transaction identifier may also be a location identifier that identities the location that the user occupies within the merchant. This may for example be a table number identifier in a restaurant. The server may maintain an association between the location identifier for a given user and their basket identifier, in this manner the server may determine a user's basket based only on their location. The location identifier may reside permanently at a fixed location in the merchant (e.g. there may be an identifier such as a barcode, alphanumeric code, QR code etc. at a table in a restaurant that a given customer can use to request their bill.

The processor may be arranged to generate the transaction identifier. The server may generate the code that the user uses to request their bill. If the server generates this identifier then it may be specific to the transaction, e.g. the basket identifier, as opposed to the location identifier option where the code may be associated with the table and therefore reused by different users in different transactions (e.g. the same code at a table in a restaurant may be used by different customers as they can only occupy the table one user (or one user party) at a time).

The transaction identifier may be embodied in the form of a scannable identifier, the scannable identifier being scannable by an image capture device of the user device which then incorporates the scanned identifier into the user request.

The scannable identifier may be a barcode, a QR code, a number, an alphanumeric code or any other suitable identifier.

According to a second aspect of the present invention there is provided a method for managing at a transaction server a merchant-user transaction between a point-of-sale system of a merchant and a user computing device, the method composing: receiving transaction data from the point-of-sale system and receiving a user request from the user computing device to complete the merchant-user transaction between the point-of-sale system and the user computing device; completing the merchant-user transaction by running a payment process in dependence on the received transaction data and user request: outputting a transaction complete communication to the point-of-sale system.

The invention extends to a non-transitory computer-readable storage medium storing executable computer program instructions implementing the second aspect of the present invention.

The present invention provides a method and system for simplifying the payment process in which specialty crafted code images may be used within the receipts without the need to alter either the point of sale hardware or to alter the software loaded thereon.

The present invention may be implemented with minimum integration to existing point of sale systems to enable the payment including preparation of the bill payment information.

The present invention provides methods and a system that allows payments to be made with the following features:

1. Allowing payments to be made by scanning a specially crafted code

2. Outputting receipts for the confirmation of the payment from preferred output devices (printers, displays, and etc.)

The above features may be achieved by the various features of the present invention as described herein by employing some or all of the following operation sets:

1. Generation of specially crafted codes either for each payer's visit, for each payer, for each order location, and/or for each bill

2. Outputting of the crafted code

3. Requesting bills

4. Calculating discounts

5. Calculating loyalty indexes

6. Constructing the contents of requested bills

7. Actioning payment with existing payment services

8. Notifying the result of the payment to preferred devices

9. Constructing the contents of receipts

10. Outputting receipts from preferred output devices

The above operations may operate to request bills and pay for them User may request bills by scanning generated and outputted specially crafted code. The Payment server may identify the requested bills from the information encoded in the code and may retrieve the bill information from existing payment systems and construct the bills and return them to the user with a Bill ID. Discounts or loyalty programs may be also applied to the bills. If the user confirms the bills are correct. the Payment server or the user may make a payment with the existing payment service. The Payment server may notify the result of the payment to multiple devices. If the payment is succeeded, receipts may be created and be outputted from preferred output devices. Staff in shops or restaurants may confirm which user has paid the bill by looking at the receipt since it contains identifiers for the user in the location.

### BRIEF DESCRIPTION OF THE DRAWINGS

FIG. 1 illustrates an architectural layout (and associated data flows) of a payment system in accordance with embodiments of the present invention;

FIG. 2 illustrates the structure of a Payment identifier Association in accordance with embodiments of the present invention;

FIG. 3 is a flowchart of a process of issuing a transaction basket identifier in Basket ID in accordance with embodiments of the present invention;

FIG. 4 is a flowchart of the process of capturing an order in accordance with embodiments of the present invention.

FIG. 5 is a flowchart of the process of issuing a bill in accordance with embodiments of the present invention;

FIG. 6 is a flowchart of the process of revising a bill in accordance with embodiments of the present invention;

FIG. 7 is a flowchart of the process of Issuing an electronic bill in accordance with embodiments of the present invention;

FIG. 6 is a flowchart of the process of issuing an electronic bill from a point of sale system on the basis of a specific location in accordance with embodiments of the present invention;

FIG. 9 is a flowchart of the process of issuing an electronic bill from a point of sale system on the basis of a transaction basket in accordance with embodiments of the present invention;

FIG. 10 is a flowchart of issuing an electronic bill from a point of sale system equipped with an interceptor module in accordance with embodiments of the present invention;

FIG. 11 is a flowchart of issuing an electronic bill from a point of sale system equipped with an interceptor module on the basis of a transaction basket in accordance with embodiments of the present invention;

FIG. 12 is a flowchart of paying for a bill in accordance with embodiments of the present invention;

FIG. 13 is a flowchart of the process of obtaining a basket identifier in accordance with embodiments of the present invention:

FIG. 14 illustrates a number of transaction scenarios between a user and a point of sale system in accordance with embodiments of the present invention;

FIG. 15 illustrates a number of transaction scenarios between a user and a point of sale system equipped with an interceptor module in accordance with embodiments of the present invention;

FIGS. 16 to 21 show a number of transaction sequences in accordance with embodiments of the present invention;

FIG. 22 illustrates the state transition of a transaction basket.

### DETAILED DESCRIPTION OF THE INVENTION

Within the following description the following terms are used:

Payment Terminal—a Payment Terminal may be any device that provides access to transactions data For example, a Point of Sale (POS) Terminal, a Process Data Quickly (PDQ) Terminal or other Electronic Commerce Systems such as on-line shops, transaction data stores, etc.

POS Application Software—the POS Application Software may comprise any software installed on a POS terminal (or other Payment Terminal) before introduction of the current system.

Printer—a Printer is any device capable of displaying or printing any image. For example, a printer attached to a POS or PDQ Terminal, computer displays, smart-phone displays or any other display equipped device, etc.

Offer (Reward)—an Offer is an Incentive given to a loyal customer (e.g. free coffee if you have collected 10 stamps etc.). The terms “Reward” and “Offer” may be used interchangeably.

OLID (Order Location ID)—an OLID is an identifier (ID) managed by the POS Application Software and issued for each order location (e.g. restaurant table or petrol station pump.) An OLIO will typically be unique within a site (e.g. store, restaurant, or retailer). An OLID may appear within the data streams sent between the POS Application Software and a Printer or between POS Application Software and an input device (e.g. a scanning device).

Basket—the Basket is a data structure managed by a Payment Server that represents the items ordered during a session that starts when a customer arrives or ordered at the outset and ends when the customer completes the transaction by paying. The Basket may be constructed based on the information captured by a Payment Enhancer at a Payment Terminal.

Payment Enhancer—a Payment Enhancer may be a software package loaded into the Payment Terminal that intercepts data sent in the communication path between the POS Application Software and a Printer or input device and sends payment/transaction data to the Payment Server

Payment Server—the Payment Server (also referred to as the transaction server) comprises a server in communication with both the Payment Terminal/POS Software Application and a Client Device

Bill—a Bill relates to information for a receipt as created by existing POS Application Software.

Electronic Bill (eBill)—Electronic Bill relates to a data structure managed by the Payment Server that represents the items that need to be paid for, applied discounts, and others. It is constructed from a Basket as a snapshot of the time when it is requested.

Basket ID—represents the identifier (ID) of a Basket

Bill ID—represents the identifier (ID) of an Electronic Bill. A Bill ID is issued each time a customer requests a Bill, and at that time previously issued Bill IDs are invalidated to ensure that only one Bill is valid for a Basket

PEID (Payment Enhancer ID)—represents an identifier (ID) managed by the Payment Server which is issued for each Payment Enhancer

User ID—represents an identifier (ID) associated with a customer

Loyalty Index—represents an index to indicate customer loyalty, e.g. number of stamps, number of points etc.

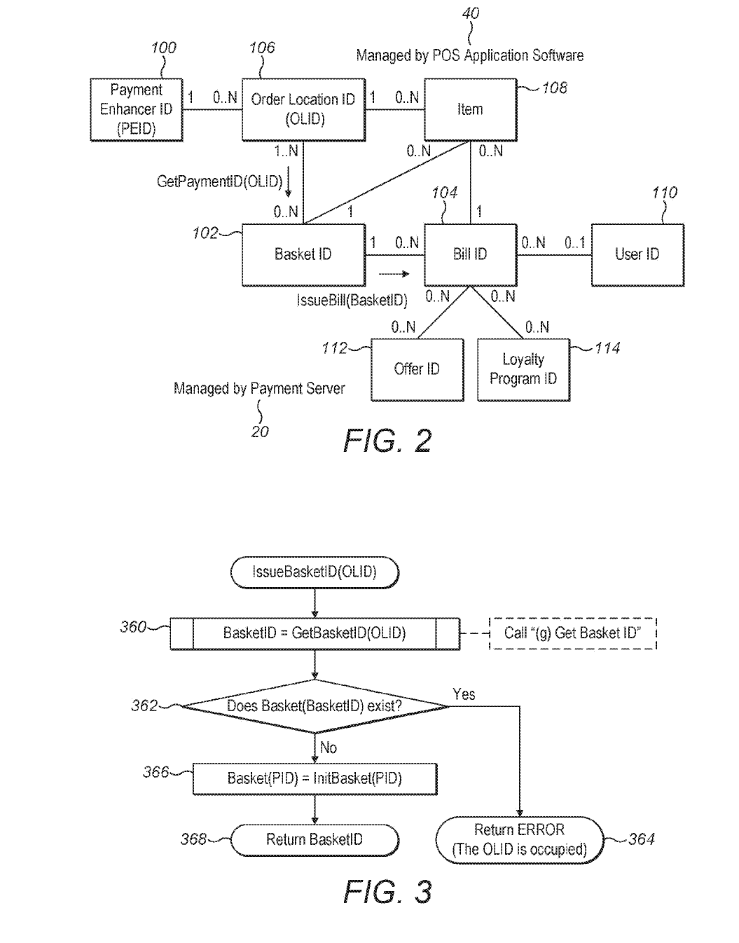

Payment ID Association—represents a data structure that represents associations among the IDs managed by the Payment Server. The Payment ID Association allows the Payment. Server to maintain information about Basket and Bill that are intercepted by Payment Enhancer at the Payment Terminal [see FIG. 2]

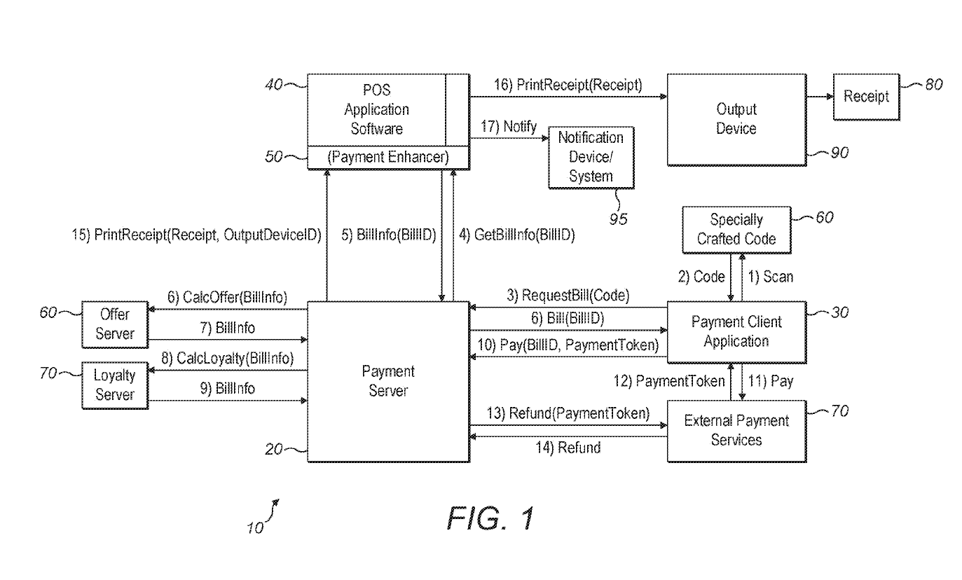

Turning now to FIG. 1, an example of an architectural layout arid control/data flows among the components in accordance with an embodiment of the present invention is shown. Within FIG. 1, solid arrows denote control flow and dotted arrows denote data flow. The transaction system in accordance with embodiments of the present invention runs in conjunction with existing Payment Terminals (such as a POS terminal) and external payment services. The transaction system 10 comprises 3 main components: a Payment Server 20, a Payment Client Application 30, and POS Application Software 40. The transaction system may additionally comprise a Payment Enhancer 50. Offer Server 60, and Loyalty Server 70 as described below. The transaction system may also comprise a notification device 95 to send notifications to the user (customer). For example, in a restaurant environment the notification device 95 may comprise a small device to notify to customers when their table is ready. In an alternative example, an application installed on a smart device owned by the user may be used to notify them. In this alternative example the notification device comprises a communications module to send the notification message to the user's device.

It is noted that the POS Application Software 40 comprises the software running on Payment Terminals, in order to implement embodiments of the present invention, the function of the POS Application Software 40 is enhanced, compared to a standard POS configuration, either by modifying the POS Application Software 40 itself or by installing a Payment Enhancer 50 within the Payment Terminal (or within the retailers payment network).

A Payment Enhancer 50 (also referred to herein as an interceptor module) is a component that may be provided to enhance the function of existing POS Application Software 40 (e.g. where it is impractical to modify that software directly because, for example, it is proprietary software to a third party). Typically the Payment Enhancer 50 may runs on the same environment as the POS Application Software. The Payment Enhancer 50 is arranged to intercept data processed by the POS Application Software 40 and is arranged to communicate with the Payment Server 20 to maintain Baskets (information about what items have been ordered) and their payment status. The Payment Enhancer 50 may also be arranged to integrate with POS Application Software 40 so that it gets access to additional information about transaction. The Payment Enhancer 50 is arranged to be capable of modifying data flowing from POS Application Software to Output Device. The functionality of Payment Enhancer may be implemented using the invention described in WO2013008041. The contents of which are herein incorporated by reference.

The Payment Server 20 is arranged to manage Baskets and their payment status. The Payment Server 20 is arranged to receive order information from the Payment Enhancer 50 and construct a Basket data structure. The server 20 is arranged to answer requests for bills that come either from the Payment Client Application 30 or the Payment Enhancer 50. On receiving a request for bill, the server 20 is arranged to calculate a bill from the information stored in a Basket. The server may also comprise functionality to generate specially crafted codes 60, such as a QR Code, that encodes an ID such as Bill ID and/or Basket ID. Such a specially crafted code may possibly encode other information such as bill data. The Payment Server 20 may be arranged to answer requests for payment that are received from the Payment Client Application 30. The server is arranged to processes payment tickets issued by external payment services 70 that were obtained either by the Payment Client Application 30 or the Payment Server 20 itself as the result of a payment execution for a customer. When the payment ticket is validated, the Payment Server settles the corresponding bill and commands the Payment Enhancer 50 to print out the receipt 80 of the payment via the output device 90. Preferably, the Payment Server is arranged to communicate with a Feedback Server (not shown). Offer Server 60, and/or Loyalty Server 70 to provide additional functions.

The Payment Client Application 30 is a component that runs on a mobile device and provides enhanced payment function for the customer. The Payment Client Application 30 is capable of decoding a specially crafted code 80 generated by the Payment Server 20. e.g. by taking an image of the code 80 using a camera device on the mobile device.

The Offer Server 60 is a component that manages offers and discounts. The offer server 60 is arranged to take Payment ID Associations and a Bill ID as inputs and checks conditions of the offers if they are applicable to the bill. If it founds applicable offers to the bill, it also calculates the discounts from the bin and the applicable offers and returns this information to the Payment Server 20.

The Loyalty Server 70 is a component that manages loyalty programs. The loyalty server 70 is arranged to take Payment ID Associations and a Bill as inputs and checks conditions of the loyalty programs if they are applicable to the bill. If it founds applicable loyalty programs to the bill, it also calculates the loyalty indexes from the bill and the applicable loyalty programs and returns this information to the payment server 20.

The Feedback Server is a component that manages feedbacks. The Feedback Server is arranged to take Payment ID Associations and a Bill ID as inputs and checks if there are feedbacks related to the bill. if it founds feedbacks related to the bill, it returns the feedbacks.

### Payment ID Association

Payment ID Association is shown in FIG. 2. The Payment ID Association is the data structure that is managed by the Payment Server 20 and/or POS Application Software 40 that represents associations among the IDs managed by the Payment Server. It consists of Payment Enhancer ID (PEID) 100, Basket ID 102, Bill ID 104, Order Location ID (OLID) 106, and Item 108 (information about ordered item.) Optionally, it may contain User ID 110, Offer ID 112, and loyalty Program ID as well.

OLID 106 and item 108 are managed by the POS Application Software 40 and the Payment Server 20 is arranged to receive these IDs from the Payment Enhancer 50 that intercepts data flowing between the POS Application Software 40 and the output device 90. Captured OLIDs 106 and items 108 are associated with other IDs like Basket ID 102 and Bill ID 104 within the Payment Server 20. An OLID 106 identifies a location where orders made. Typical examples are table number at a restaurant and pump number at a petrol station.

Within the transaction system 10 shown in FIG. 1, a PEID is assigned to each Payment Enhancer 50 (each Payment Terminal may comprise a separate instance of a payment enhancer). The PEID is attached to ail requests sent from the Payment Enhancer 50 to the Payment Server 20. Since an OLID 106 may only be unique within a specific domain like a restaurant or a petrol station, the Payment Server 20 is arranged to manage PEIDs 100 in order to construct global unique ID from the OLID 106.

A Basket ID 102 is created for each session that starts when a customer arrives at a retail environment or when the first order is made and ends when a transaction/payment completes. Typically a Basket ID 102 is associated with just one OLIO 106. A Basket ID 102 however may be associated with plural OLIDs 105 in the event that a customer is moved to different order locations during the session (e.g. they move table within a restaurant).

A Bill ID 104 is created each time a customer asks for a bill. The bill ID 104 is associated with a Basket ID 102 and a Basket ID may be associated with plural of Bill IDs. The Bill ID 104 is associated with plural Items that represent the ordered items included in the bill.

The User ID 110 is associated with a Bill ID 104 if a customer provides his/her User ID 110 when he/she requested a bill. The provision of a User ID 110 and association with a particular transaction allows other servers like Loyalty Server 70 and Offer Server 60 to take the bill information into consideration when the payment server 20 calculates a bill.

Offer IDs 112 are created and associated with a Bill ID 104 in order to represent that the offerings are applicable to the bill.

Loyalty Program IDs 114 are created and associated with a Bill ID 104 In order to represent that the loyalty programs are applicable to the bill.

### Basket and Bill

A Basket is a data structure created and managed by the Payment Server 20. FIG. 22 shows the lifecycle of a Basket. The Basket is created and initialized when a customer arrives at a retail environment or when they first make an order. This slate 352 is called “Ordering.” While in this state, orders can be made but payment is not allowed since no bill is issued yet. The state will be changed to “Issued a Bill” when a customer requests a bill 354. White in this state, the customer can pay for the issued bill or make additional orders. If an additional order is made, the state is changed back to “Ordering” and the bill is invalidated. If the bill amount is paid 356, the state will be changed from “issued a Bill” to “Settled.”

### Functions Provided by Payment Server

The Payment Server 20 provides the following 11 functions to Payment Enhancer 50, POS Application Software 40, and Payment Application Client 30.

“Function (a)”—Issue Basket ID

The flowchart of the issuance of a basket ID is shown in FIG. 3. A basket may be obtained with an OLID 106 and a current time stamp (step 360). If there is a valid basket (step 362) for the OLID 106 and the time stamp, the corresponding Basket ID 102 is to be returned (364). If there is no valid basket for the OLID 106 and the time stamp, a new basket is created (366) and its Basket ID 106 is to be returned (368).

“Function (b)”—Capture Order

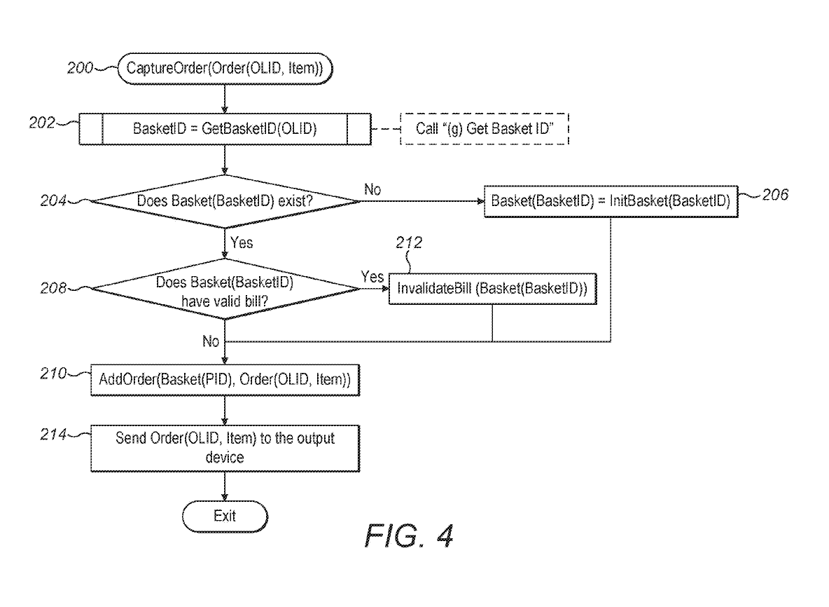

The flowchart of the capturing order is shown in FIG. 4. The Payment Enhancer 50 calls this function when it has intercepted order information at a POS Application Software 40 (Step 200). In step 202, the function executes the “Function (g)” described below (“Get BasketID”) to obtain the BasketID 102 associated with the specific OLID 106. In step 204 the existence of a BasketID is checked. If no BasketID is associated with the OLIO, the function generates, in step 206, new BasketID and associates it with the OLID 106. Then the function checks (step 208) if a Basket of the obtained BasketID exists or not if not (step 210). it creates and initializes new Basket, if a Basket exists already (step 212). it further checks if the Basket already has a valid bill and invalidates it to disallow paying for the bill. Then it creates new item (order information) and associates it with the Basket. Finally, it composes an output image and sends it (step 214) to output device.

“Function (c)”—Issuing a Bill

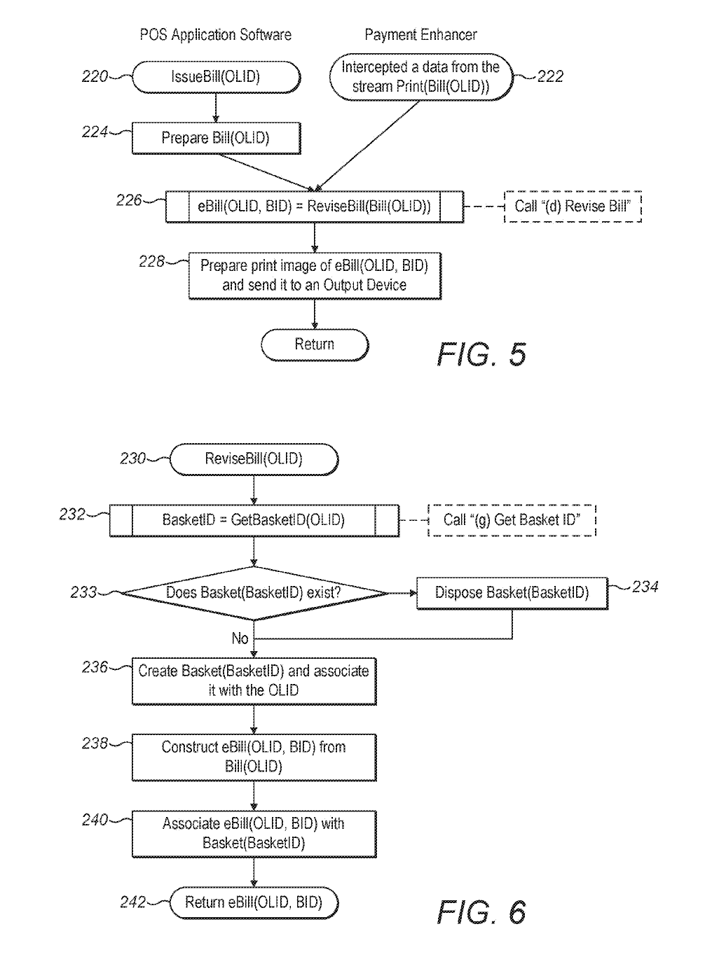

The flowchart of the issuance of a bill is shown in FIG. 5. This function may be called either by the POS Application Software 40 (step 220, in the event that the POS software can be modified to provide payment data to the payment server 20) or the Payment Enhancer 50 (step 222, in the event that the POS software cannot be modified and a payment enhancer is installed on the payment terminal).

When POS Application Software 40 calls this function, it prepares bill data (step 224) as usual. On the other hand, the Payment Enhancer 50 prepares bill data by intercepting data flowing in the communications path the POS Application Software 40 and the output device 90. Once bill data is obtained. “Function (d)” (the “Revise Bill” function) is called in step 226 to get a revised electronic bill. Then it prepares an output image of the electric bill and sends it to an output device 90 in step 228.

“Function (d)”—Revise Bill

The flowchart of the revising of bill is shown in FIG. 6. This function may be called either by the POS Application Software 40 or the Payment Enhancer 50 (in a similar way as per Function (c) above). In either case, the calling component (40, 50) provides bill information along with OLID 106 First, this function extracts bill information and OLID from the Information provided by the caller (step 230). Next, it cans (step 232) “Function (g)” (“Get BasketID”, as described below) to obtain the BasketID associated with the OLIO extracted from the provided information. In step 233, the function checks whether the BasketID exists already. If a Basket of the returned BasketID exists already (step 234), it disposes the Basket at this time since the returned Basket is for a previous payer (a previous customer). It may check if the Basket is already settled or not now. Then it creates a new Basket (step 236) and associates it with the OLID. Finally it constructs an electronic bill from the extracted bill information (step 238), associates it with the created Basket (step 240), and returns the constructed electronic bill to the calling component (step 242).

“Function (e-1)”—Issue Electronic Bill for Bill ID

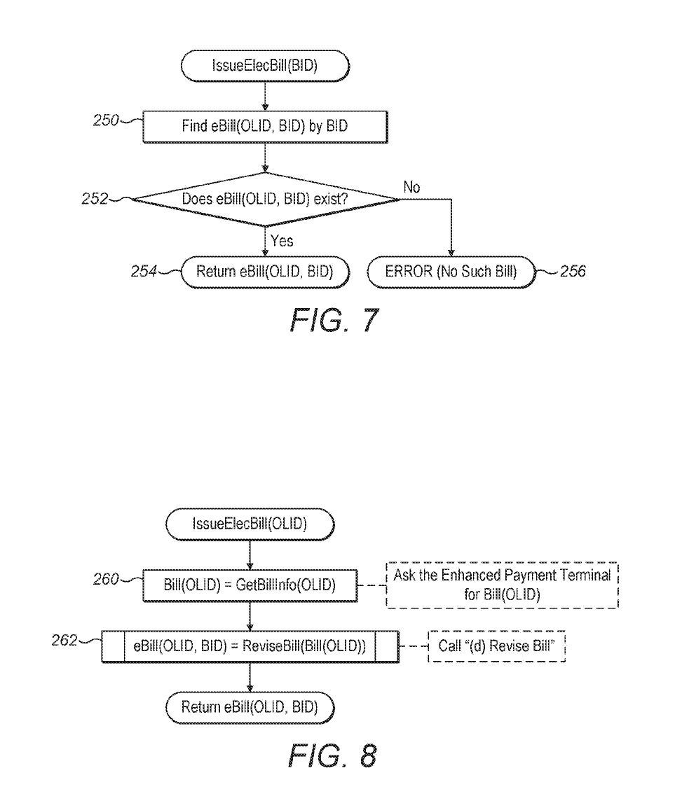

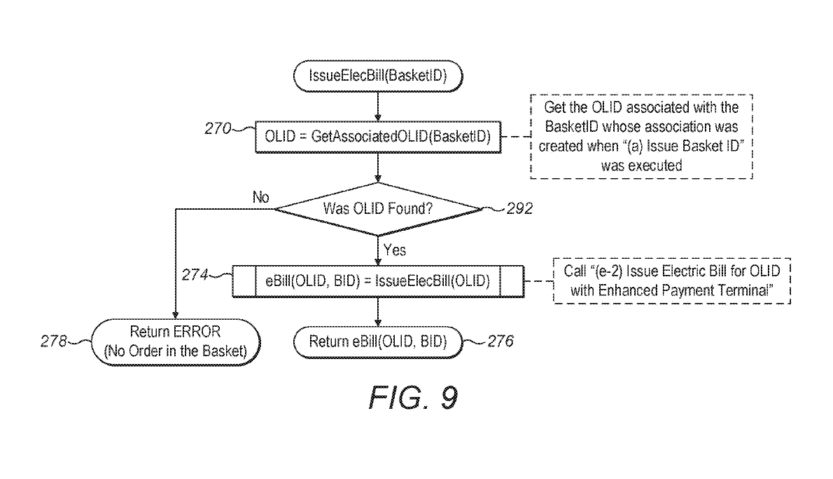

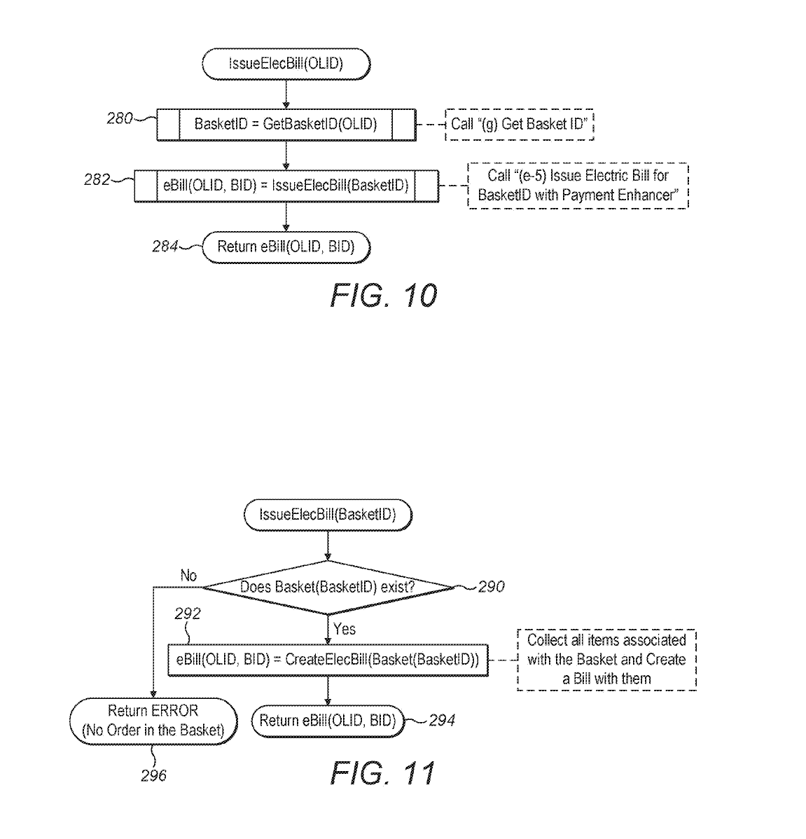

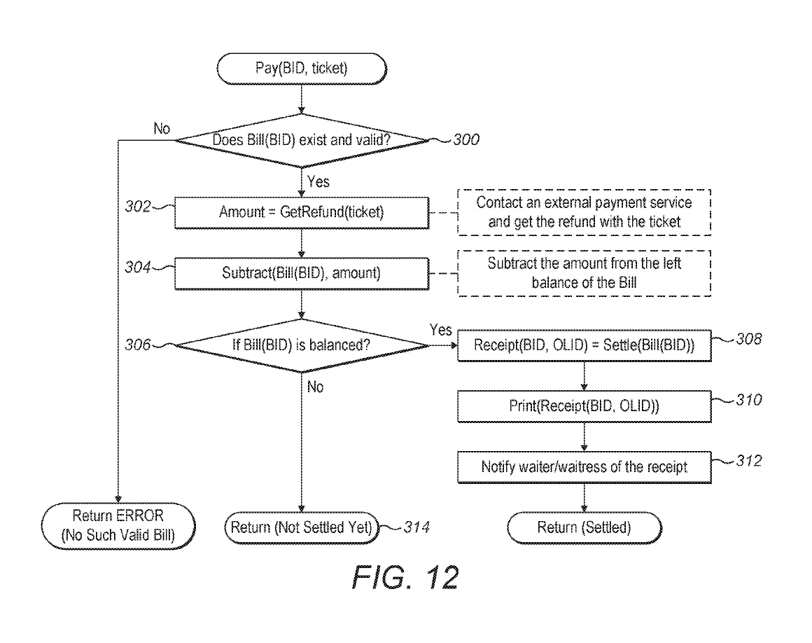

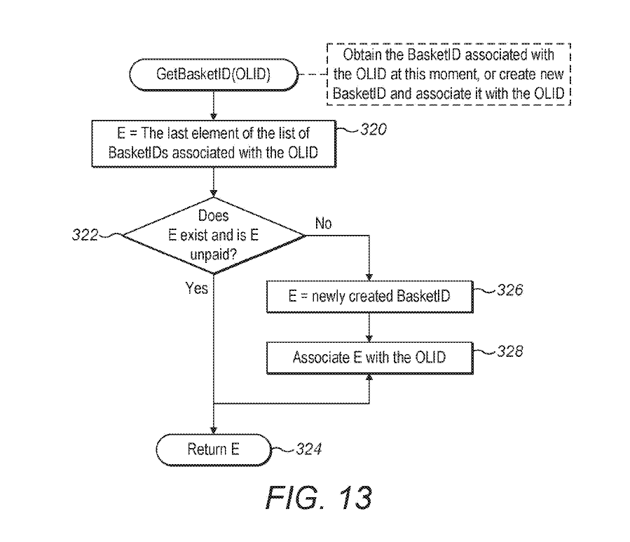

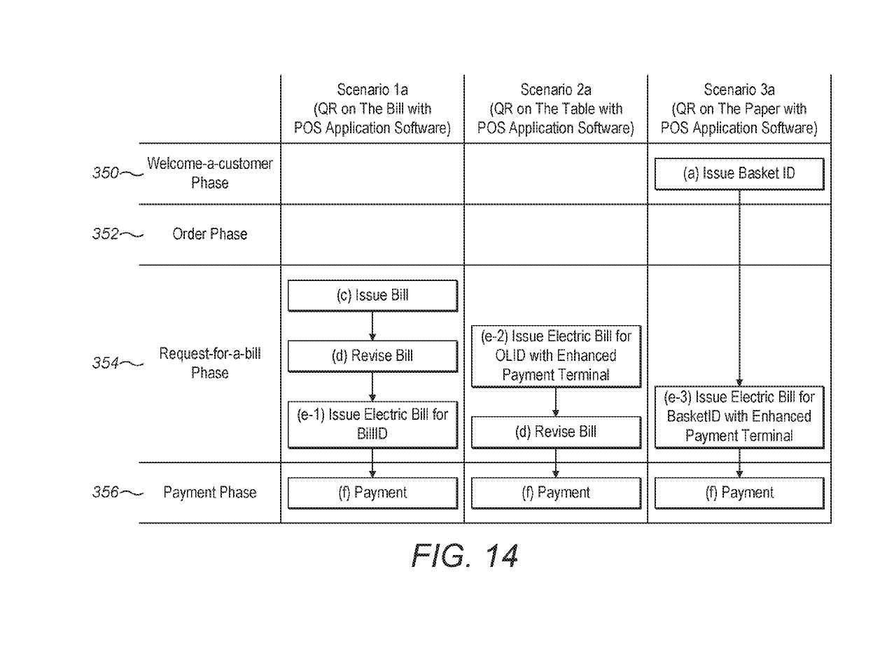

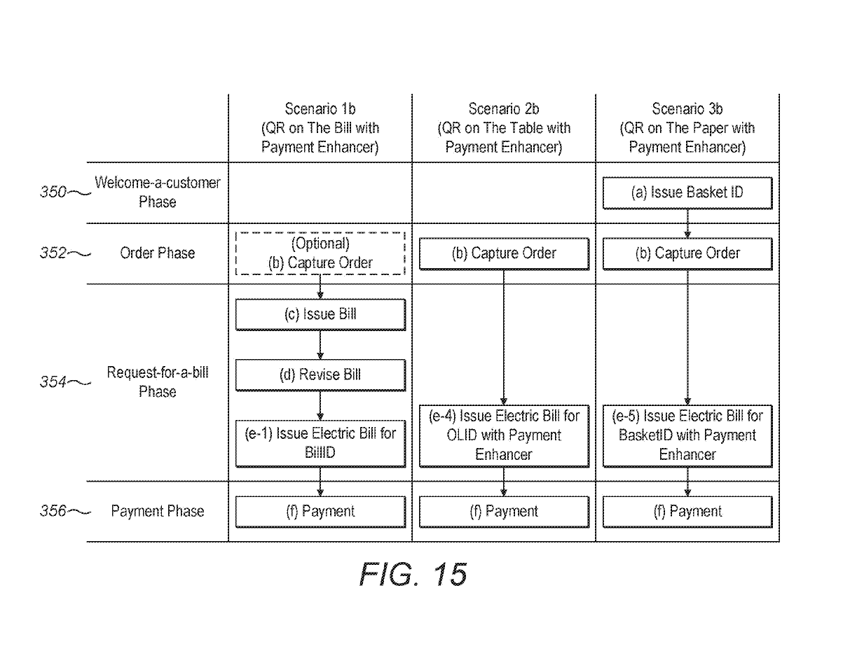

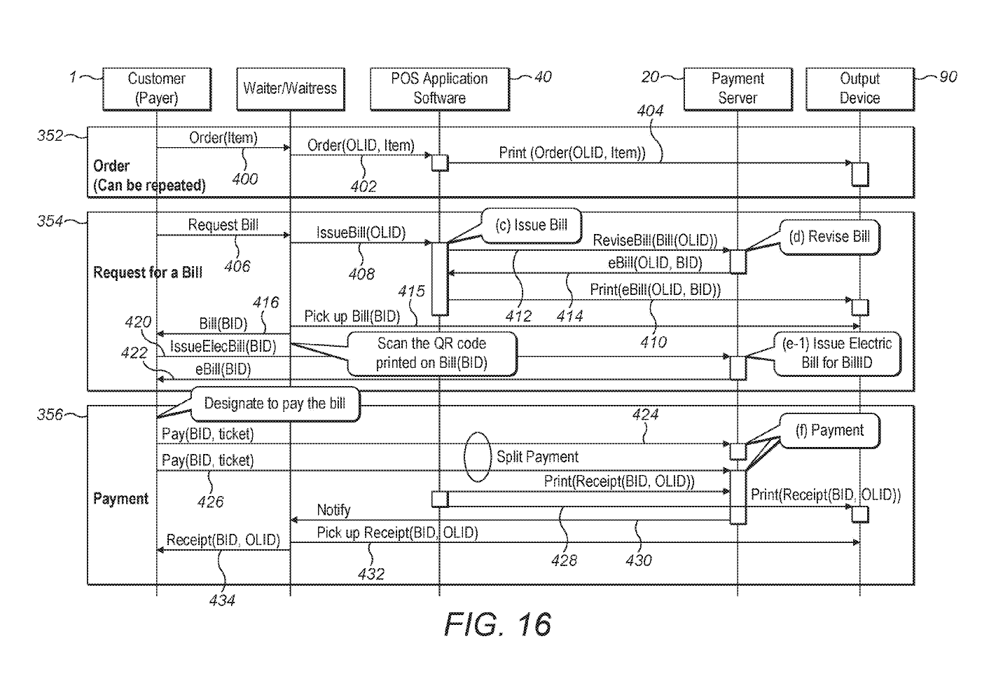

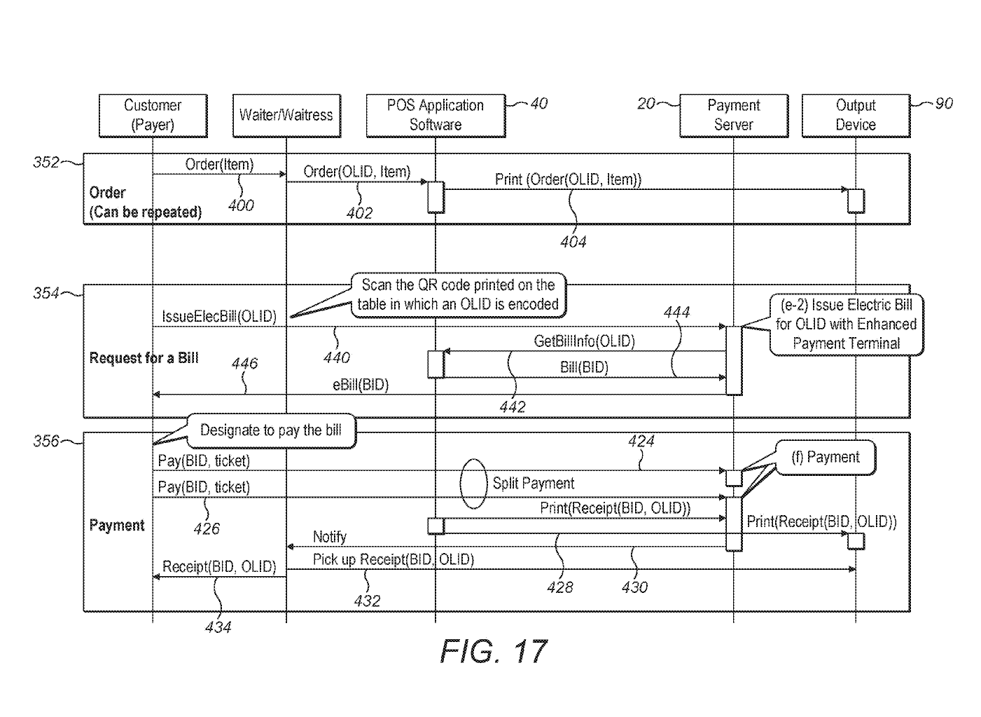

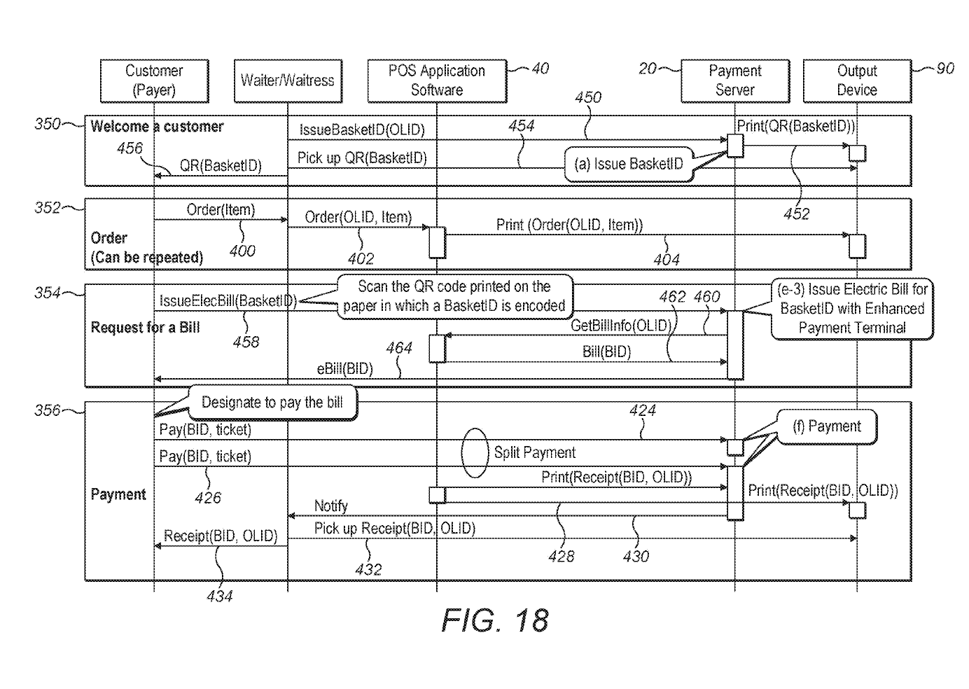

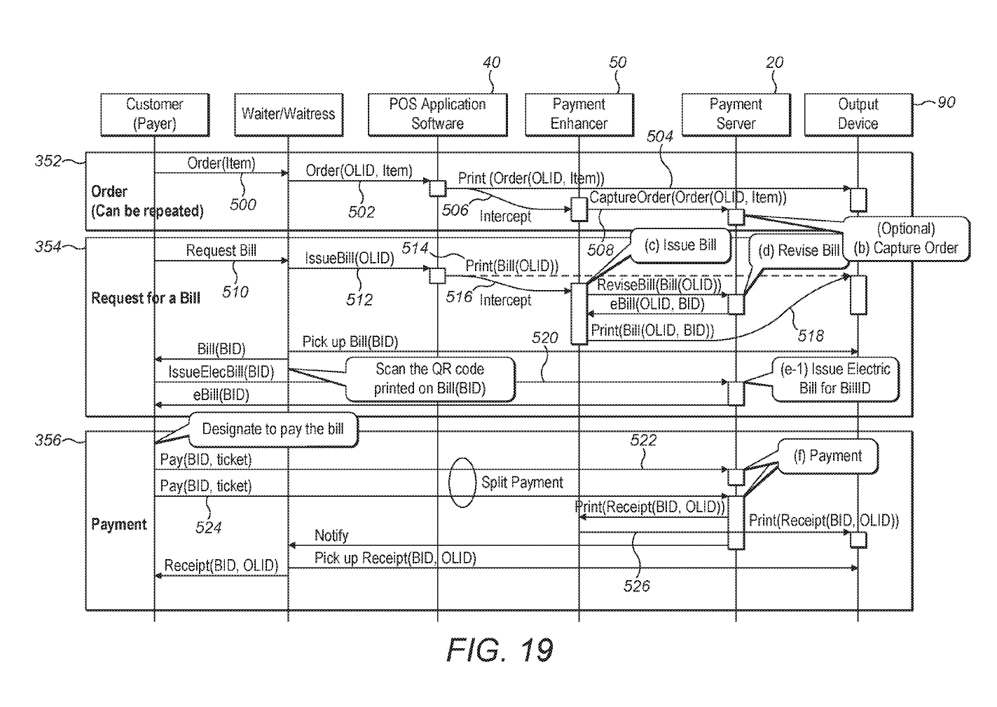

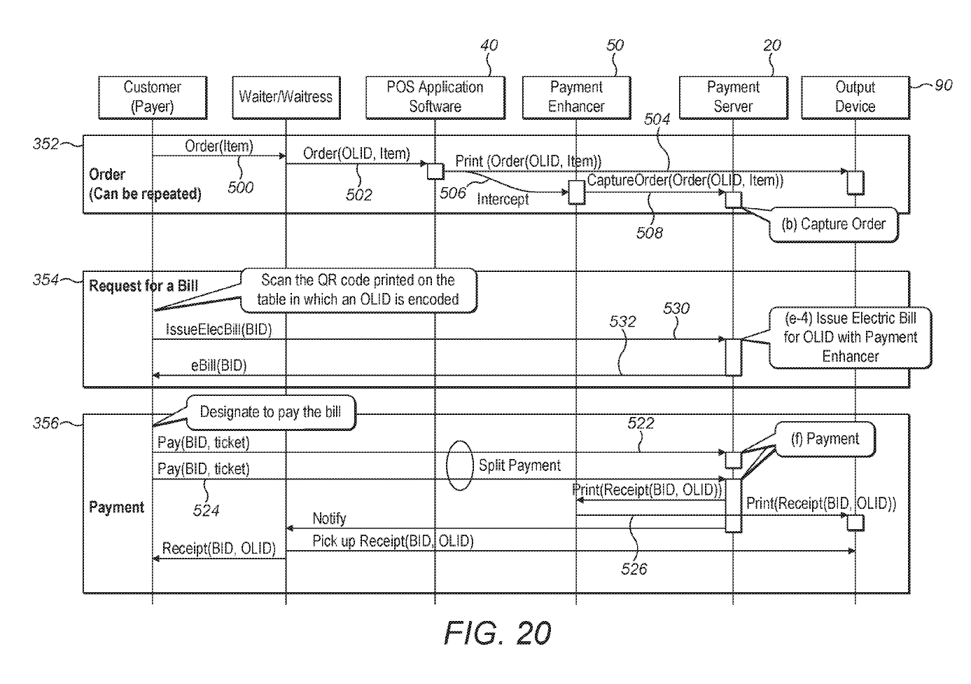

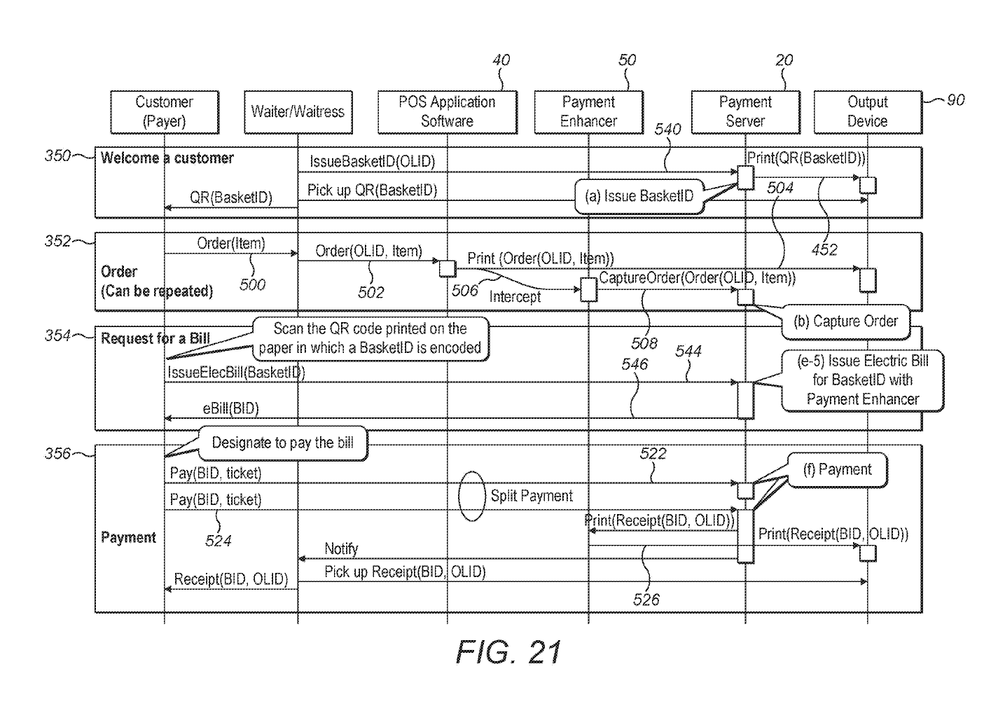

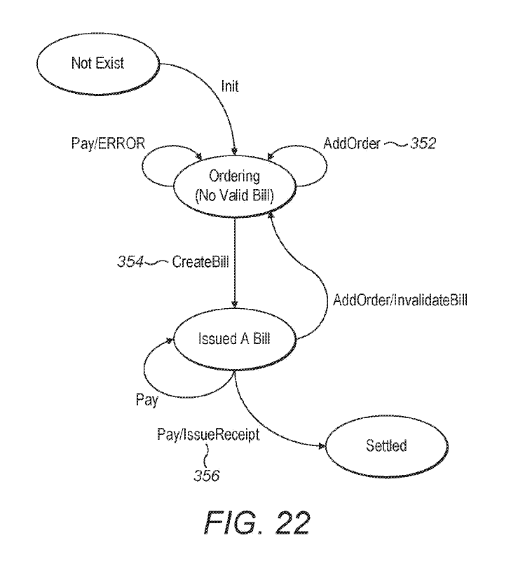

The flowchart of the issuance of an electronic bill from a receipt containing a bill ID is shown in FIG. 7. The Payment Application Client 30 calls this (unction when a payer scans a QR Code 60 printed on a bill 80 that encodes a bill ID. First, this function tries to find an electronic bill of the specified bill ID (step 250). Then the function checks if an eBill exists (step 252). If an electronic bill is found this is returned to the Payment Application Client in step 254. Otherwise, the function returns an error to the Payment Application Client in step 256 to tell that the bill does not exist.

“Function (e-2)”—Issue Electric Bill for OLID with POS Application Software

The flowchart of the issuance of an electronic bill from an OLID 106 is shown in FIG. 8. This function is called if the transaction system 10 according to embodiments of the present invention is integrated with POS Application Software 40, and when a customer (payer) scans a QR Code (or other identifier) printed on the table, the identifier encoding the OLID 106 relating to that table. First, this function asks (step 260) the POS Application Software 40 for bill information of the specified OLID 106. Then it calls (step 262) “Function (d)” above (“Revise Bill”) to obtain a revised electronic bill and returns the revised eBill to the caller (the payment application client).

“Function (e-3)”—Issue Electronic Bill for BasketID with POS Application Software

The flowchart of the issuance of an electronic bill from a BasketID is shown in FIG. 9. This function is called if the transaction system 10 according to embodiments of the present invention is integrated with POS Application Software 40, and when a payer scans a QR Code printed on a paper that encodes a BasketID. First, in step 270/272, this function tries to find the OLID 106 associated with the specific BasketID 102. This association should have already been created when the paper is issued with the “Function (a)” (“Issue Basket ID”). If the OLID was found (step 274), it calls “Function (e-2)” above (“Issue Electronic Bill for OLID with POS Application Software”) to create an electronic bill for the OLID and returns (step 276) the result to the caller. Otherwise, it returns (step 278) an error to tell the payment client application 30 that the basket does not exist.

“Function (e-4)”—Issue Electronic Bill for OLID with Payment Enhancer

The flowchart of the creation of a bill for an OLID is shown in FIG. 10. This function is called if the transaction system 10 according to embodiments of the present invention is configured with a Payment Enhancer 50 (as opposed to being implemented via modification of the POS Software Application 40), and when a payer scans a QR Code 80 printed on the table that encodes an OLID 106. First, this function calls (step 280) the “Function (g)” described below (“Get Basket ID”) to obtain the Basket associated with the specified OLID 106. Then the function of FIG. 10 calls, in step 282. “Function (e-5)” described below (“Issue Electric Bill for BasketID with Payment Enhancer”) to obtain an electronic bill for the obtained Basket, and returns it (step 284) to the caller (the Payment Enhancer 50).

“Function (e-5)”—Issue Electronic Bill for BasketID with Payment Enhancer

The flowchart of the issuance of electronic bill for a BasketID 102 is shown in FIG. 11. This function is called if the transaction system 10 is configured with a Payment Enhancer 50, and when a payer scans a QR Code 60 printed on a paper that encodes a BasketID 102. This function checks if the Basket of the specified BasketID exists or not (step 290). if the Basket was found, the function (e-5) collects, in step 292, all items associated with the Basket and creates an electronic bill with them, and returns the eBill to the caller (in step 294). Otherwise, it returns an error to tell that no such Basket was found (step 296).

“Function (f)”—Payment

The flowchart of the payment is shown in FIG. 12. The Payment Client Application 30 calls this function when the customer agrees to pay for a bill displayed on his mobile device. It takes two parameters: BID (bill ID 104) and a payment ticket which was issued as an evidence of a payment previously executed with an external payment service 70 (see FIG. 10). First, the function checks if the provided BillID exists (step 300). If the BillID exists the function, in step 302, gets a refund by contacting the external payment service 70. Next, in step 304, it subtracts the refund amount from the left balance of the bill and checks in step 306 if the bill is balanced. If the bill is balanced as the result of subtraction, it marks the bill, in step 308, as settled and generates a receipt image including Bill ID and OLID. Then it commands Payment Enhancer 50 to print the image (step 310) to an output device 90 and notifies a waiter/waitress of the receipt (step 312) in some method. If the bill is not balanced yet, it tells the caller (Payment Client Application 30) in step 314 that the payment is not settled yet expecting another payment is executed again.

“Function (g)”—Get Basket ID

The flowchart of the way to get a basket ID is shown in FIG. 13. This function is called internally within the Payment Server 20 by other functions as described above. It returns the basket ID 102 associated with the OLID 106 at the time when it is called, or creates a new basket ID 102 and associates it with the OLID 106. First, it fries to find (step 320) the most recently added basket ID 102 in the association from the specified OLID 106 and then checks if the basket is unpaid (step 322). If such basket ID exists and it is still unpaid, it just returns the found basket ID (324) However, if no such basket ID 102 was found, it creates new basket ID (step 326), associates it with the OLID 106 (step 328), and returns it (step 324).

### Implementation

Payment processes in accordance with embodiments of the present invention may be implemented using a selection of the Payment server functions described section (see “Functions provided by the Payment Server”).

FIG. 14 shows the functions that may be selected for possible 3 scenarios for the case when a suitably modified POS Application Software 40 is interacting with the Payment Server 20:—

Scenario 1a: QR on The Bill;

Scenario 2: QR on The Table, and,

Scenario 3: QR on The Paper.

FIG. 15 shows another selection of functions for the case when the transaction system is configured with a Payment Enhancer 50.

For FIGS. 14 and 15. the functions can be categorized into 4 phases: welcome-a-customer phase 350, order phase 352, request-for-a-bill phase 354, and payment phase 356.

When the POS Application Software 40 is interacting with the Payment Server 20 (as per FIG. 14). the 1^{st} scenario (QR on The Bill) requires the following payment server 20 functions: Function (c), Function (d), and Function (e-1) while the 2^{nd} scenario (QR on The Table) requires the Function (e-2) and Function (d) The 3^{rd} scenario requires Function (a) at the welcome-a-customer phase, and Function (e-3).

When the system is configured with a Payment Enhancer 50, the 1^{st} scenario (QR on The Bill) requires the following payment server 20 functions Functions (b), Function (c), Function (d), and Function (e-1). Scenario 2 (QR on The Table) requires the functions: Function (b) and Function (e-4). The 3^{rd} scenario requires Function (a) at the welcome-a-customer phase. Function (b), and Function (e-5).

All scenarios regardless of whether the transaction system 10 is configured as per FIG. 14 or FIG. 15. requires Function (f) at the payment phase.

### EXAMPLES

Scenario 1a: QR on The Bill with POS Application Software (QR Code Is Printed On a Bill)

This scenario is illustrated in FIGS. 14 and 16.

### a) Order Phase (352)

Suppose that a customer C visits a restaurant and gives an order (400) to a waiter/Waitress W. The waiter/waitress W then inputs the orders (402) to a POS terminal T (the POS terminal including the POS application software 40) which outputs an order ticket (404) to an output device O (like a printer 90) so that the waiter-Waitress W can give the order to the chefs. This is a typical protocol currently found in restaurants.

### b) Request-For-A-Bill Phase (354)

When the customer C finishes dinner, they call the waiter/Waitress W to ask for a bill (406). Then the waiter/waitress W operates the POS terminal T (40) to issue a bill (408), in which the terminal T sends a command to the output device O 90 to print (410) a bill. This is a typical protocol found in restaurants.

At this moment, the POS terminal T 40 communicates with the payment server P 20 to revise (412) and print (414) a bill. The Payment Server P 20 generates a BID (Bill ID 104) at this time and encodes the ID as a specially crafted code like QR-code 60. The payment server P 20 adds the code to the bill before sending (415) to the output device O 90 The payment server P 20 may also modify the bill by applying some discounts at this moment. Then the payment server P 20 notifies the waiter-Waitress W of the bill who then delivers (416) the bid to the customer C.

### c) Payment Phase (356)

The customer C pays for the bill by using a mobile phone with scanning device. It is assumed that a payment client application A 30 has already been installed on the mobile device., and a payment card of the customer C is registered with the payment client application 30. When the customer C scans the QR code 60 primed on the bill, the payment client application A 30 obtains the BIO encoded in the QR code 60. The payment client application A 30 sends (420) a request to obtain (422) the bill information and shows the result to the customer C. The bill information may be encoded in the QR code 60 or it may be obtained from the payment server P 20 by specifying the BID. When the customer C agrees on the payment, the payment client application A 30 sends (424) payment information (e.g. credit card information) to the payment server P 20 along with the amount of payment The customer C may specify tips for the waiter/waitress W at this time. The payment may be split (426) so the payment will be repeated until alt of the balance is paid.

When all of the balance is paid, the payment server P 20 commands the output device O 90 to prim (428) a receipt 80 for the bill and notify (430) it to the waiter/waitress W. Then the waiter/waitress W picks up (432) the receipt and delivers it (434) to C to say “thank you.”

Scenario 2a: QR on The Table with POS Application Software (QR Code is Affixed on Each Table)

This scenario is illustrated in FIGS. 14 and 17.

a) Order phase (352)

This is the same as described in relation to scenario 1a above.

### b) Request-For-A-Bill Phase (354)

When the customer C finishes dinner, they request a bill by using a mobile phone with scanning device It is assumed that a payment client application A 30 has already been installed, and a QR code 50 in which an OLID (Order Location ID) 106 is encoded is affixed on each table.

When the customer C scans the QR code affixed on their table with the payment client application A 30, the payment client application A sends (440) a request for a bill to the payment server P 20 along with the OLID 106 encoded in the QR code 60. The payment server P 20 finds the basket associated with the specified OLID and issues a BID (Bill ID 104) Then the payment server 20 asks (442) the POS Application Software 40 to provide (444) the bill information, and constructs an electronic bill from it. The payment server P 20 may also modify the bill by applying some discounts at this moment. The prepared electronic bill is sent (446) back to the payment client application A 30 so that the customer C can confirm and pay for it on his/her mobile phone.

### c) Payment Phase

This is the same as described in relation to Scenario 1a above.

Scenario 3a: QR on The Paper with POS Application Software (QR Code is Printed for Each Customer)

This scenario is illustrated in FIGS. 14 and 18.

a′) Welcome-A-Customer Phase

The waiter-waitress W requests (450) the payment server P for a PID (Payment ID) when the customer C is welcomed at live restaurant. Then the payment server P 20 generates a unique PID and commands the output device O 90 to print out (452) a paper containing a QR code 60 that encodes the PID. The printed paper will be picked up (454) by the waiter-waitress W and delivered (456) to the customer C.

### a) Order Phase

This is the same as described in relation to scenario 1a above.

### b) Request-For-a-Bill Phase

When C finishes dinner, they request (458) a bill by using a mobile phone with scanning device. Here it is assumed that a payment client application A 30 has already been installed on the mobile device.

When the customer C scans (458) the QR code 60 printed on the paper received at the Welcome-a-customer phase, the payment client application A 30 sends a request for a bill to the payment server P 20 along with the PID encoded in the QR code 60. The payment server P 20 finds the basket associated with the specified PID and issues a BID (Bill ID 104). Then the payment server asks (460) the POS Application Software 40 to provide (462) the bill information, and constructs an electronic bill from it. The payment server P 20 may also modify the bill by applying some discounts at this moment. The prepared bill will be sent back (464) to the payment client application A 30 so that the customer C can confirm and pay for it on his/her mobile phone.

### c) Payment Phase

This is the same as for Scenario 1a above.

Scenario 1b: QR on The Bill with Payment Enhancer (QR Code is Printed On a Bill)

This scenario is illustrated in FIGS. 15 and 19.

### a) Order Phase

Suppose that a customer C visits a restaurant and orders (500) Items via a waiter/waitress W. The waiter/waitress W inputs (502) the orders to a POS terminal T 40 which in turn outputs (504) an older ticket to an output device O (like a printer 90) so that the waiter/waitress W can provide the orders to the check. This is a typical protocol currently in restaurants.

(Order-capturing step) Optionally, the payment enhancer 50 intercepts (506) the order information flowing between the payment terminal T 40 and the output device O 90 in order to extract (508) order information and associate it with a basket for the customer that will be referenced when a bill is requested later on.

### b) Request-For-A-Bill Phase

When C finishes dinner, they call (510) for the bill. Then the waiter/waitress W operates the payment terminal T 20 to issue (512) a bill and the terminal T 40 commands the output device O 90 to print (514) a bill. This is a typical protocol currently in restaurants.

At this moment, Payment enhancer 50 intercepts (516) the bill information flowing between the terminal T 40 and output device O 90 in order to capture the request and to extract order information included in it. The Payment server 20 generates a BID (Bill ID) at this time and encodes the ID as a specially crafted code like QR-code 60. The payment server 20 (and payment enhancer 50) adds the code to the bill before sending (518) to the output device O 90. The Payment enhancer 50 may also modify the Mil by applying some discounts at this moment. Then Payment server 20 notifies the waiter/waitress W of the bill who delivers the bill to C.

### c) Payment Phase

The customer C pays for the Mil by using a mobile phone with a suitable scanning device. Here it is assumed that a payment client application A 30 has already been installed, and a payment card of the customer C is registered.

When the customer C scans (520) the QR code 60 printed on the bill. the payment client application A 30 obtains the BID encoded in the QR code 60. The payment client application A 30 sends a request to obtain the bill information and shows the result to the customer C. The bill information may be encoded in the QR code 60 or it may be obtained from the payment server P 20 by specifying the BID.

When the customer C agrees on payment, the payment client application A 30 sends (522) payment information (e.g. credit card information) to the Payment server 20 along with the amount of payment. The customer C may specify tips for the waiter/waitress W at this time. The payment may be split (524) so the payment will be repeated until all of the balance is paid.

When all of the balance is paid, the payment server P 20 commands,, via the payment enhancer 50 the output device O to print (526) a receipt tor the bill and notify this to the waiter/waitress W. Then the waiter/waitress W picks up the receipt and delivers it to the customer C to say “thank you.”

Scenario 2b: QR on The Table with Payment Enhancer (QR Code is Affixed on Each Table)

This scenario is illustrated in FIGS. 15 and 20.

### a) Order Phase

This is the same as for Scenario 1b above except for the difference in the order-capturing step. In this scenario, the order-capturing step is not optional so that the payment server P 20 can construct bill information without intercepting the bill information flowing between payment terminal T 40 and the output device O 90 in the Request-for-a-Bill phase.

### b) Request-For-A-Bill Phase

When the customer C finishes dinner, the customer C requests a bill by using a mobile phone with a suitable scanning device (e.g. a camera) Here it is assumed that a payment client application A 30 has already been installed, and a QR code 60 in which an OLID (Order Location ID 106) is encoded is affixed on each table.

When the customer C scans the QR code 60 affixed on their table with the payment client application A, the payment client application A 30 sends (530) a request for a bill to the payment server P 20 along with the OLID 106 encoded in the QR code 60. The payment server P finds the basket associated with the specified OLID and issues a BID (Bill ID 104). Then the payment server prepares a bill containing the information stored in the basket and the BID. The payment server P 20 may also modify the bill by applying some discounts at this moment. The prepared bill will be sent back (532) to the payment client application A 30 so that the customer C can confirm and pay for if on his/her mobile phone.

### c) Payment Phase

This is the same as for Scenario 1b above.

Scenario 3b: QR on The Paper with Payment Enhancer (QR Code is Printed For Each Customer)

This scenario is illustrated in FIGS. 15 and 21.

a′) Welcome-A-Customer Phase

The waiter/waitress W requests (540) the payment server P 20 to provide a PID (Payment ID) when he/she welcomes the customer C at the restaurant. Then the payment server P 20 generates a unique PID and commands the output device O 90 to print (542) out a paper containing a QR code 60 that encodes the PID. The printed paper will be picked up by the waiter/waitress W and delivers it to the customer C

### a) Order Phase

This is the same as for Scenario 2b.

### b) Request-For-A-Bill Phase

When the customer C finishes dinner, they request a bat by using a mobile phone with scanning device. Here it is assumed that a payment client application A 30 has already been installed. When the customer C scans the QR code 60 printed on the paper received at the Welcome-a-customer phase, the payment client application A 30 sends (544) a request for a bill to the payment server P along with the PID encoded in the QR code. The payment server P 20 finds the basket associated with the specified PID and issues a BID (Bill ID 104). Then it prepares a bill containing the information stored in the basket and the BID. The payment server P 20 may also modify the bill by applying some discounts at this moment. The prepared bill will be sent back (546) to the payment client application A 30 so that the customer C can confirm and pay for it on his/her mobile phone.

### c) Payment Phase

This is the same as for Scenario 2b above.

As the person skilled in the art will appreciate, modifications and variations to the above embodiments may be provided, and further embodiments may be developed, without departing from the spirit and scope of the invention. Reference to standards and proprietary technologies are provided for the purpose of describing effective implementations, and do not limit the scope of the invention.

1. A transaction server for managing a merchant-user transaction between a point-of-sale system of a merchant and a user computing device, the server comprising:
an input arranged to receive transaction data from the point-of-sale system and to receive a user request from the user computing device to complete the merchant-user transaction between the point-of-sale system and the user computing device,
a processor arranged to compete the merchant-user transaction by running a payment process in dependence on the received transaction data and user request;
an output arranged to output a transaction compete communication to the point-of-sale system

2. A server as claimed in claim 1, wherein the input receives transaction data from an interceptor module at the point-of-sale system, the interceptor module being arranged to intercept transaction data in the communication path between a point-of-sale terminal and a physical device and to send the intercepted transaction data to the server.

3. A server as claimed in claim t or claim 2, wherein the transaction data received from the point-of-sale system comprises a transaction identifier.

4. A server as claimed in any one of claims 1 to 3, wherein the transaction data received from the point-of-sale system comprises transaction item data.

5. A server as claimed in claim 4, wherein the transaction item data comprises a transaction item identifier and associated transaction item price data for each transaction item identifier.

6. A server as claimed in any one of claims 1 to 5, wherein transaction data is received from the point-of-sale system poor to receiving the user request from the user.

7. A server as claimed in claim 6, wherein the processor is arranged to open a data record in a basket database upon receiving transaction data.

8. A server as claimed in claim 7, wherein the processor is arranged to populate the basket database with received transaction item data.

9. A server as claimed m any one of claims 1 to 5, wherein the server is arranged to request transaction data from the point-of-sale system upon receipt of the user request.

10. A server as claimed in any one of claims 1 to 9, wherein me user request received at the input comprises a request for a bill and the processor is arranged to retrieve transaction data relating to the merchant-user transaction and to generate a bill for the user.

11. A server as claimed in claim 10, wherein transaction data relating to the transaction comprises at least one transaction item identifier and associated transaction item price data.

12. A server as claimed in claim 10 or 11, wherein the processor is arranged to generate an electronic bill and the output is arranged to output the electronic bill.

13. A server as claimed in claim 12, wherein the output is arranged to output the electronic bill to the user computing device

14. A server as claimed in claim 12, wherein the output is arranged to output the electronic bill to the point-of-sale system

15. A server as claimed in any of claims 10 to 14, wherein the processor is arranged to provide, within the electronic bill, connection details relating to a third party payment processor.

16. A server as claimed in claim 15, wherein the input is arranged lo receive a payment token from the user computing device and the server is subsequently arranged to initiate a communication session with the third party payment processor in order to submit the payment token in order to receive a refund corresponding to the total transaction amount.

17. A server as claimed in claim 16, wherein the input is arranged to receive a bill identifier to enable the processor to retrieve all transaction data relating to the merchant-user transaction.

18. A server as claimed in any preceding claim, wherein the user request comprises a transaction identifier to allow the server to identify the merchant-user transaction.

19. A server as claimed in claim 18, wherein the transaction identifier comprises a location identifier managed by the point-of-sale system which identifiers each transaction ordering location at the merchant.

20. A server as claimed in claim 19 or claim 20: wherein the transaction identifier comprises a basket identifier.

21. A server as claimed in any of claims 18 to 20, wherein the processor is arranged to generate the transaction identifier.

22. A server as claimed in any of claims 18 to claim 21, wherein the order identifier is embodied in the form of a scannable identifier, the scannable identifier being scannable by an image capture device of five user device.

23. A server as claimed in claim 22, wherein the scannable identifier is a barcode.

24. A server as claimed in claim 22, wherein the scannable identifier is a QR code.

25. A method for managing at a transaction server a merchant-user transaction between a point-of-sale system of a merchant and a user computing device, the method comprising:
receiving transaction data from the point-of-sale system and receiving a user request from the user computing device to complete the merchant-user transaction between the point-of-sale system and the user computing device;
completing the merchant-user transaction by running a payment process in dependence on the received transaction data and user request;
outputting a transaction complete communication to the point-of-sale system.

26. A non-transitory computer-readable storage medium storing executable computer program instructions implementing the method of claim 25.
